(19) United States
(12) Patent Application Publication
(10) Pub. No.: US 2022/0240008 A1
(43) Pub. Date: Jul. 28, 2022

(54) HYBRID AUDIO BEAMFORMING SYSTEM

(71) Applicant: Shure Acquisition Holdings, Inc., Niles, IL (US)

(72) Inventors: Wenshun Tian, Palatine, IL (US); John Casey Gibbs, Chicago, IL (US); Michael Ryan Lester, Colorado Springs, CO (US); Mathew T. Abraham, Colorado Springs, CO (US)

(21) Appl. No.: 17/586,213

(22) Filed: Jan. 27, 2022

Related U.S. Application Data
(60) Provisional application No. 63/142,711, filed on Jan. 28, 2021.

(51) Int. Cl. H04R 3/00

(52) U.S. Cl. CPC H04R 3/005; H04R 2201/401

(57) ABSTRACT

Hybrid audio beamforming systems and methods with narrower beams and improved directivity are provided. The hybrid audio beamforming system includes a time domain beamformer for processing upper frequency band signals of an audio signal using a time domain beamforming technique, and a frequency domain beamformer for processing groups of lower frequency band signals of the audio signal using frequency domain beamforming techniques.

### CROSS-REFERENCE TO RELATED APPLICATIONS

This application claims the benefit of U.S. Provisional Patent Application No. 63/142,711, filed Jan. 28, 2021, which is fully incorporated by reference in its entirety herein.

### TECHNICAL FIELD

This application generally relates to an audio beamforming system. In particular, this application relates to a hybrid audio beamforming system having narrower beams and improved directivity, through the use of a time domain beamformer for processing upper frequency band signals of an audio signal and a frequency domain beamformer for processing lower frequency band signals of the audio signal.

### BACKGROUND

Conferencing environments, such as conference rooms, boardrooms, video conferencing applications, and the like, can involve the use of microphones for capturing sound from various audio sources active in such environments. Such audio sources may include humans speaking, for example. The captured sound may be disseminated to a local audience in the environment through amplified speakers (for sound reinforcement), and/or to others remote from the environment (such as via a telecast and/or a webcast). The types of microphones and their placement in a particular environment may depend on the locations of the audio sources, physical space requirements, aesthetics, room layout, and/or other considerations. For example, in some environments, the microphones may be placed on a table or lectern near the audio sources. In other environments, the microphones may be mounted overhead to capture the sound from the entire room, for example. Accordingly, microphones are available in a variety of sizes, form factors, mounting options, and wiring options to suit the needs of particular environments.

Traditional microphones typically have fixed polar patterns and few manually selectable settings. To capture sound in a conferencing environment, many traditional microphones can be used at once to capture the audio sources within the environment. However, traditional microphones tend to capture unwanted audio as well, such as room noise, echoes, reverberations, and other undesirable audio elements. The capturing of these unwanted noises is exacerbated by the use of many microphones.

Array microphones having multiple microphone elements can provide benefits such as steerable coverage or pick up patterns having beams or lobes, which allow the microphones to focus on the desired audio sources and reject unwanted sounds such as room noise. The ability to steer audio pick up patterns provides the benefit of being able to be less precise in microphone placement, and in this way, array microphones are more forgiving. Moreover, array microphones provide the ability to pick up multiple audio sources with one array microphone or unit, again due to the ability to steer the pickup patterns.

Beamforming is used to combine signals from the microphone elements of array microphones in order to achieve a certain pickup pattern having one or more beams or lobes. However, due to longer wavelengths of sound at lower frequencies, the widths of beams generated using typical beamforming algorithms (e.g., delay and sum operating in the time domain) on broadband audio signals can be wider than what is configured or desired. Furthermore, the directionality of the beams may not be optimal when using typical beamforming algorithms on broadband audio signals. The wider beam widths and the non-optimal beam directionality can result in the sensing of undesired audio, reduced performance of the array microphone, and user dissatisfaction with the array microphone. In addition, using frequency domain beamforming across the entire frequency range can be computationally and memory resource intensive.

Accordingly, there is an opportunity for an audio beamforming system that addresses these concerns. More particularly, there is an opportunity for a hybrid audio beamforming system having narrower beams and improved directivity, through the use of a time domain beamformer for processing upper frequency band signals of an audio signal and a frequency domain beamformer for processing lower frequency band signals of the audio signal.

### SUMMARY

The invention is intended to solve the above-noted problems by providing audio beamformer systems and methods that are designed to, among other things: (1) provide a time domain beamformer to generate a first beamformed signal based on upper frequency band signals derived from audio signals, and using a time domain beamforming technique; (2) provide a frequency domain beamformer to generate a second beamformed signal based on lower frequency band signals derived from the audio signals, and using a first frequency domain beamforming technique for a first group of the lower frequency band signals and using a second frequency domain beamforming technique for a second group of the lower frequency band signals; (3) output a beamformed output signal based on the first beamformed signal generated by the time domain beamformer and the second beamformed signal generated by the frequency domain beamformer; (4) have an improved width and directionality of the beams, particularly in lower frequencies; and (5) reduce the use of computational and memory resources by avoiding the use of frequency domain beamforming across the entire frequency range.

In an embodiment, a beamforming system includes a first beamformer configured to generate a first beamformed signal based on first frequency band signals derived from a plurality of audio signals, a second beamformer configured to generate a second beamformed signal based on second frequency band signals derived from the plurality of audio signals, and an output generation unit in communication with the first and second beamformers. The first beamformer is configured to process the first frequency band signals using a first beamforming technique, the second beamformer is configured to process the second frequency band signals using a second beamforming technique, and the output generation unit is configured to generate a beamformed output signal based on the first beamformed signal and the second beamformed signal.

In another embodiment, a beamforming system includes a first beamformer configured to generate a first beamformed signal based on upper frequency band signals derived from a plurality of audio signals, a second beamformer configured to generate a second beamformed signal based on lower frequency band signals derived from the plurality of audio signals, and an output generation unit in communication with the first and second beamformers. The first beamformer is configured to process the upper frequency band signals using a time domain beamforming technique, and the second beamformer is configured to process a first group of the lower frequency band signals using a first frequency domain beamforming technique and a second group of the lower frequency band signals using a second frequency domain beamforming technique. The output generation unit is configured to generate a beamformed output signal based on the first beamformed signal and the second beamformed signal.

In a further embodiment, a method includes receiving a plurality of audio signals; generating a first beamformed signal based on upper frequency band signals derived from the plurality of audio signals, using a time domain beamforming technique; generating a first beamformed signal based on upper frequency band signals derived from the plurality of audio signals, using a time domain beamforming technique; and generating a beamformed output signal based on the first beamformed signal and the second beamformed signal.

In another embodiment, a beamforming system includes a first beamformer configured to generate a first beamformed signal based on first frequency band signals derived from a plurality of audio signals, a second beamformer configured to generate a second beamformed signal based on second frequency band signals derived from the plurality of audio signals, and an output generation unit in communication with the first and second beamformers. The first beamformer is configured to process the first frequency band signals using a time domain beamforming technique, and the second beamformer is configured to process a first group of the second frequency band signals using a first frequency domain beamforming technique, and a second group of the second frequency band signals using a second frequency domain beamforming technique. The output generation unit is configured to generate a beamformed output signal based on the first beamformed signal and the second beamformed signal.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram of a hybrid audio beamforming system for use with an array microphone, in accordance with some embodiments.

FIG. 2 is a flowchart illustrating operations for the beamforming of audio signals of a plurality of microphones using the hybrid audio beamforming system of FIG. 1, in accordance with some embodiments.

FIG. 3 is a flowchart illustrating operations for the beamforming of upper frequency band signals derived from the audio signals of the plurality of microphones and using a time domain beamformer, in accordance with some embodiments.

FIG. 4 is a flowchart illustrating operations for the beamforming of lower frequency band signals derived from the audio signals of the plurality of microphones and using a frequency domain beamformer, in accordance with some embodiments.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

The hybrid audio beamforming systems and methods described herein can enable array microphones to have narrower beams, improved beam directionality, and better overall performance across different frequency ranges. The hybrid audio beamforming system may include a time domain beamformer configured to process upper frequency band signals using a time domain beamforming technique, and a frequency domain beamformer configured to process groups of lower frequency band signals using multiple frequency domain beamforming techniques. The upper frequency band signals and the lower frequency band signals may be derived from audio signals, such as audio signals from microphone elements of an array microphone. The hybrid audio beamforming system may generate a beamformed output signal based on the first beamformed signal from the time domain beamformer and the second beamformed signal from the frequency domain beamformer.

The frequency domain beamformer may convert the time domain audio signal into the frequency domain using a transform such as a discrete Fourier Transform (DFT) with a hop size less than the DFT block size. The frequency domain beamformer may utilize a first frequency domain beamforming technique to process a first group of the lower frequency band signals, such as lower frequency components of the lower frequency band signals. The frequency domain beamformer may also utilize a second frequency domain beamforming technique to process a second group of the lower frequency band signals, such as upper frequency components of the lower frequency band signals. By using multiple frequency domain beamforming techniques in the frequency domain beamformer, the frequency domain beamformer may generate narrower beams with improved directionality for audio in lower frequency ranges. The beamformed signal from the frequency domain beamformer may be converted to the time domain such as an inverse DFT, and the converted time domain signal may be further smoothed using the weighted overlap-add (WOLA) method.

As such, combining the time domain beamformer that uses a time domain beamforming technique and the frequency domain beamformer that uses frequency domain beamforming techniques can result in beam widths and directionality that are more optimal over different frequency ranges while using the same sets of microphone elements in an array microphone. In addition, the increased computational and memory resources needed when using frequency domain beamforming across the entire frequency range can be avoided. Latency, computational resources, and the storage of weight coefficients for the beamformers can therefore be minimized through the use of the hybrid audio beamforming systems and methods described herein.

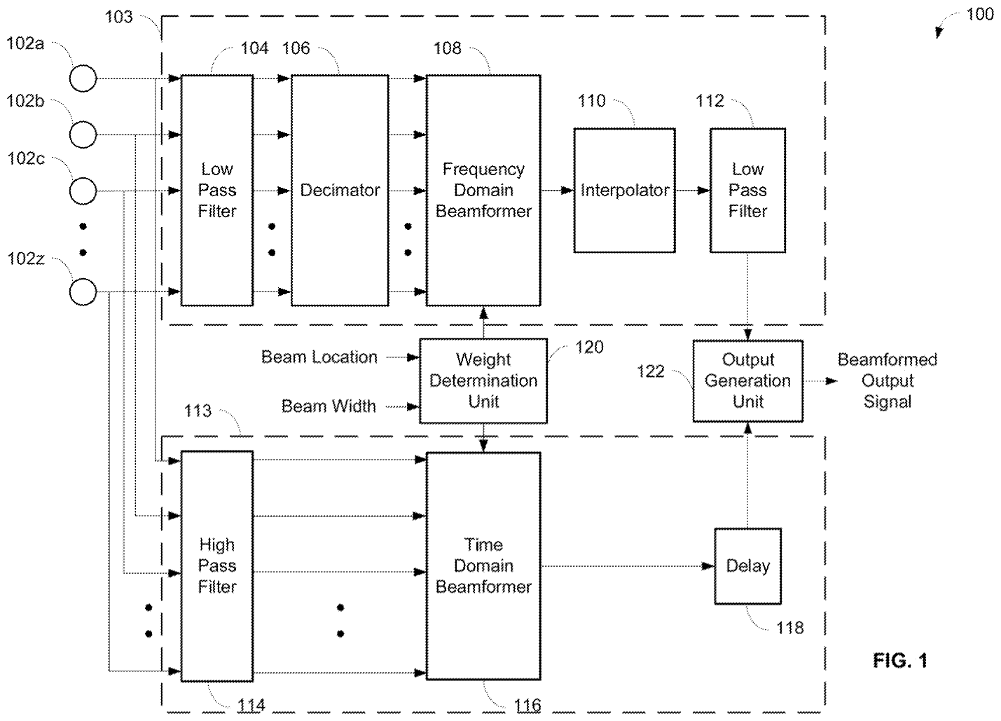

FIG. 1 is a block diagram of a hybrid audio beamforming system 100. The hybrid audio beamforming system 100 may include microphone elements 102a, b, c, . . . , z that are included in an array microphone; a lower frequency band signal path 103 that includes a low pass filter 104, a decimator 106, a frequency domain beamformer 108, an interpolator 110, and a low pass filter 112; an upper frequency band signal path 113 that includes a high pass filter 114, a time domain beamformer 116, and a delay element 118; a weight determination unit 120; and an output generation unit 122. Various components included in the hybrid audio beamforming system 100 may be implemented using software executable by a computing device with a processor and memory, and/or by hardware (e.g., discrete logic circuits, application specific integrated circuits (ASIC), programmable gate arrays (PGA), field programmable gate arrays (FPGA), etc.

The array microphone that includes the microphone elements 102a, b, c, . . . , z can detect sounds from audio sources at various frequencies. The array microphone may be utilized in a conference room or boardroom, for example, where the audio sources may be one or more human speakers and/or other desirable sounds. Other sounds may be present in the environment which may be undesirable, such as noise from ventilation, other persons, audio/visual equipment, electronic devices, etc. In a typical situation, the audio sources may be seated in chairs at a table, although other configurations and placements of the audio sources are contemplated and possible.

The array microphone may be placed on a table, lectern, desktop, etc. so that the sound from the audio sources can be detected and captured, such as speech spoken by human speakers. The array microphone may include any number of microphone elements 102a, b, c, . . . , z, and be able to form multiple pickup patterns using the hybrid beamforming audio system 100 so that the sound from the audio sources is more consistently detected and captured. The microphone elements 102a, b, c, . . . , z may be arranged in any suitable layout, including in concentric rings and/or be harmonically nested. The microphone elements 102a, b, c, . . . , z may be arranged to be generally symmetric or may be asymmetric, in embodiments. In further embodiments, the microphone elements 102a, b, c, . . . , z may be arranged on a substrate, placed in a frame, or individually suspended, for example. An embodiment of an array microphone is described in commonly assigned U.S. Pat. No. 9,565,493, which is hereby incorporated by reference in its entirety herein.

The microphone elements 102a, b, c, . . . , z may each be a MEMS (micro-electrical mechanical system) microphone, in some embodiments. In other embodiments, the microphone elements 102a, b, c, . . . , z may be electret condenser microphones, dynamic microphones, ribbon microphones, piezoelectric microphones, and/or other types of microphones. In embodiments, the microphone elements 102a, b, c, . . . , z may be unidirectional microphones that are primarily sensitive in one direction. In other embodiments, the microphone elements 102a, b, c, . . . , z may have other directionalities or polar patterns, such as cardioid, subcardioid, or omnidirectional.

Each of the microphone elements 102a, b, c, . . . , z in the array microphone may detect sound and convert the sound to an audio signal. Components in the array microphone, such as analog to digital converters, processors, and/or other components, may process the audio signals and ultimately generate one or more digital audio output signals. The digital audio output signals may conform to the Dante standard for transmitting audio over Ethernet, in some embodiments, or may conform to another standard. In other embodiments, the microphone elements 102a, b, c, . . . , z in the array microphone may output analog audio signals so that other components and devices (e.g., processors, mixers, recorders, amplifiers, etc.) external to the array microphone 100 may process the analog audio signals.

If the microphone elements 102a, b, c, . . . , z are only used with a typical beamformer (e.g., a delay and sum beamformer operating in the time domain), then the beam width may be wider than desired and the directivity of the beam may not be optimal, especially at lower frequencies. This may be due to the longer wavelengths of sound at these lower frequencies. Furthermore, beamforming of lower frequencies in the time domain can result in excessive side lobes, relatively high latencies, and/or higher computational load during processing.

However, as described in further detail herein, both the lower frequency band signal path 103 (including the frequency domain beamformer 108) and the upper frequency band signal path 113 (including the time domain beamformer 116) may be in communication with the microphone elements 102a, b, c, . . . , z. In particular, the frequency domain beamformer 108 may be used to process lower frequency band signals that are derived from the audio signals of the microphone elements 102a, b, c, . . . , z. The lower frequency band signals may be from 0-12 kHz, for example. The time domain beamformer 116 may be used to process upper frequency band signals that are also derived from the audio signals of the microphone elements 102a, b, c, . . . , z. The upper frequency band signals may be from 12-24 kHz, for example. As such, using the hybrid audio beamforming system 100 may result in beam widths that are narrower and with improved directionality over different frequencies, including at lower frequencies.

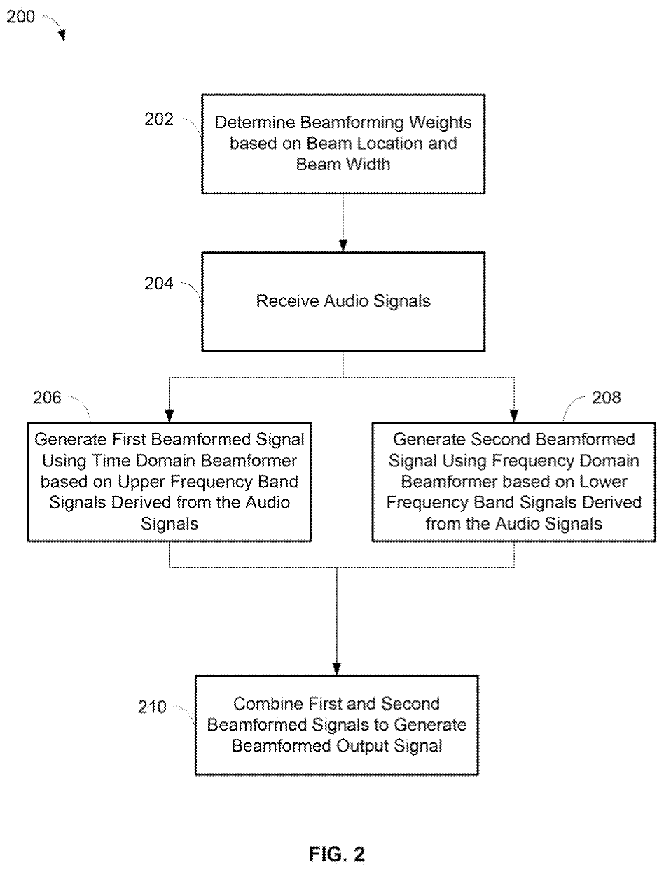

An embodiment of a process 200 for the hybrid beamforming of audio signals in the array microphone is shown in FIG. 2. The process 200 may be utilized to output a beamformed output signal from the array microphone using the hybrid audio beamforming system 100 shown in FIG. 1, where the beamformed output signal has a narrower beam and improved directionality. One or more processors and/or other processing components (e.g., analog to digital converters, encryption chips, etc.) within or external to the system 100 may perform any, some, or all of the steps of the process 200. One or more other types of components (e.g., memory, input and/or output devices, transmitters, receivers, buffers, drivers, discrete components, etc.) may also be utilized in conjunction with the processors and/or other processing components to perform any, some, or all of the steps of the process 200.

At step 202, the weight determination unit 120 may determine the weight coefficients for the frequency domain beamformer 108 (which processes the lower frequency band signals) and the time domain beamformer 116 (which processes the upper frequency band signals), based on a desired location and width of a beam. In some embodiments, the desired location and width of a beam may be determined programmatically or algorithmically using automated decision making schemes, e.g., automatic focusing, placement, and/or deployment of a beam. Embodiments of such schemes are described in commonly assigned U.S. patent application Ser. Nos. 16/826,115 and 16/887,790, which are hereby incorporated by reference in their entirety herein. In other embodiments, the desired location and width of a beam may be configured by a user, e.g., via a user interface on an electronic device in communication with the weight determination unit 120.

The desired location of a beam may be determined or configured as a particular three-dimensional coordinate relative to the location of the array microphone, such as in Cartesian coordinates (i.e., x, y, z), or in spherical coordinates (i.e., radial distance r, polar angle θ (theta), azimuthal angle φ (phi)), for example. The desired width of a beam may be determined or configured in gradations (e.g., narrow, medium, wide, etc.), or as an angle of the field of view (e.g., degrees, change in degrees, percentage change, etc.), for example.

In some embodiments, some or all of the weight coefficients for various locations and widths of the beams may be predetermined and stored in a memory in the weight determination unit 120 or that is in communication with the weight determination unit 120. In other embodiments, some or all of the weight coefficients for various locations and widths of the beams may be calculated on the fly, in order to reduce the amount of memory needed for storage of the weight coefficients. For example, it may be possible to calculate such weight coefficients on the fly for a delay and sum beamforming technique operating in the frequency domain in a relatively efficient and low latency manner. The calculations can take advantage of the constant gain for all the microphone elements 102a, b, c, . . . , z and the uniform incremental phase shift amounts.

In embodiments, the weight coefficients for various locations and widths of the beams for certain beamforming techniques (e.g., minimum variance distortionless response operating in the frequency domain) may be generated using static noise covariance to obtain a narrower beam width, or using dynamic noise covariance for improved signal to noise ratio.

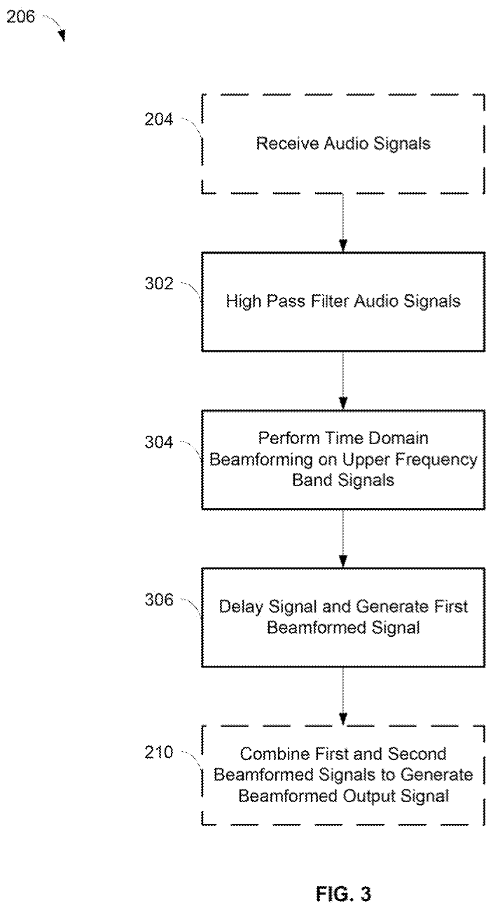

Audio signals from the microphone elements 102a, b, c, . . . , z may be received at step 204 at the lower frequency band signal path 103 (in embodiments, at the low pass filter 104) and also at the upper frequency band signal path 113 (in embodiments, at the high pass filter 114). At step 206, a first beamformed signal may be generated using the time domain beamformer 116 based on upper frequency band signals derived from the audio signals from the microphone elements 102a, b, c, . . . , z received at step 204, and through the use of a time domain beamforming technique. The upper frequency band signals may include middle and higher frequencies, e.g., 12-24 kHz. The time domain beamforming technique used in the time domain beamformer 116 may utilize the weight coefficients determined at step 202. An embodiment of step 206 is described below with respect to FIG. 3.

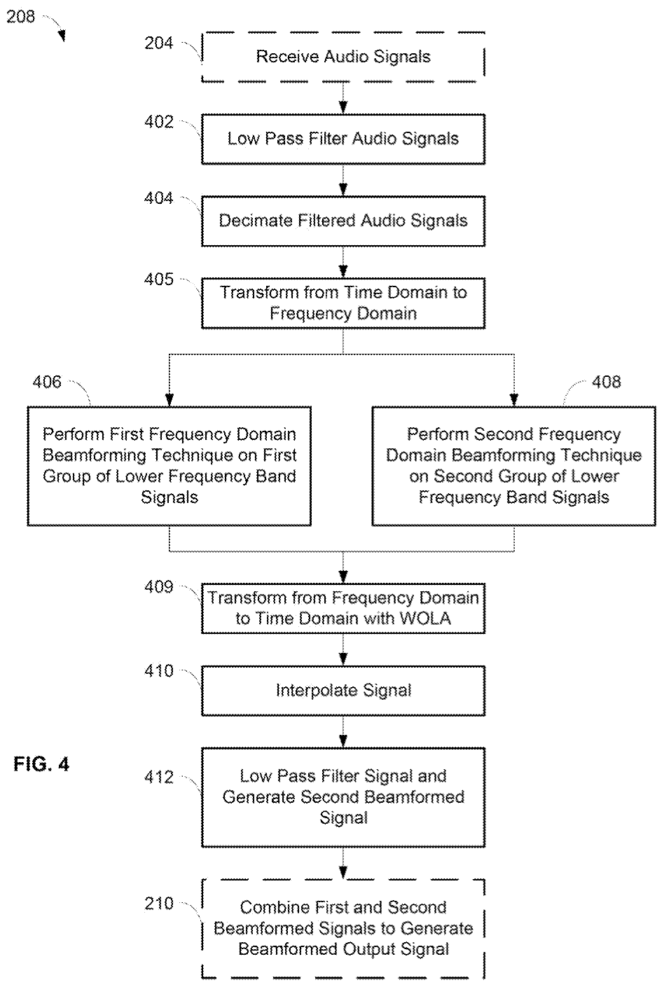

At step 208, a second beamformed signal may be generated using the frequency domain beamformer 108 based on lower frequency band signals derived from the audio signals from the microphone elements 102a, b, c, . . . , z received at step 204, and through the use of frequency domain beamforming techniques on different groups of the lower frequency band signals. The audio signals may be converted from the time domain to the frequency domain in order to produce the lower frequency domain signals utilized in the frequency domain beamformer 108. The lower frequency band signals may include signals with lower frequencies than the upper frequency band signals, e.g., 0-12 kHz. The frequency domain beamforming techniques used in the frequency domain beamformer 108 may utilize the weight coefficients determined at step 202. An embodiment of step 208 is described below with respect to FIG. 4. In embodiments, steps 206 and 208 may be performed substantially at the same time or may be performed at different times.

A beamformed output signal may be generated by the output generation unit 122 at step 210. The beamformed output signal may be generated by combining the first beamformed signal and the second beamformed signal that are generated by the time domain beamformer 116 and the frequency domain beamformer 108, respectively. In embodiments, the first beamformed signal and the second beamformed signal may be combined by being summed together by the output generation unit 122 to generate the beamformed output signal. The beamformed output signal may be a digital signal, such as a signal conforming to the Dante standard for transmitting audio over Ethernet, for example. In embodiments, the beamformed output signal may be output to components or devices (e.g., processors, mixers, recorders, amplifiers, etc.) external to the hybrid audio beamforming system 100 and/or the array microphone.

FIG. 3 shows an embodiment of a process 206 for the time domain beamforming of upper frequency band signals using the upper frequency band signal path 113 that includes the time domain beamformer 108. The process 206 shown in FIG. 3 may correspond to step 206 of the process 200 shown in FIG. 2. In the process 206 of FIG. 3, the audio signals received at step 204 of the process 200 may be filtered at step 302 by the high pass filter 114. The high pass filter 114 may be configured to pass the audio signals having frequencies in an upper frequency range, e.g., 12-24 kHz. In embodiments, the spectrum response of the high pass filter 114 may be matched to the spectrum response of the low pass filter 104 (of the lower frequency band signal path 103), in order to flatten the spectrum response of the broadband signal, i.e., the beamformed output signal.

At step 304, the upper frequency band signals from the high pass filter 114 may be processed by the time domain beamformer 116 using a time domain beamforming technique. The time domain beamformer 116 may utilize a delay and sum beamformer technique, in embodiments. As described previously, the weight coefficients used by the time domain beamformer 116 may be received from the weight determination unit 120 at step 202, based on the desired location and width of the beam.

At step 306, the signal generated by the time domain beamformer 116 may be delayed by the delay element 118 to generate the first beamformed signal that is provided to the output generation unit 122. The output generation unit 122 can combine the first and second beamformed signals at step 210 of the process 200, as described previously. The delay element 118 may add an appropriate amount of delay to the signal from the time domain beamformer 116 in order to align the signal with the second beamformed signal generated by the lower frequency band signal path 103. This may be due to the lower frequency band signal path 103 having a larger latency due to its additional components (i.e., low pass filters 104, 112, decimator 106, and interpolator 110), as well as due to the frequency domain beamformer 108. Accordingly, the amount of delay added by the delay element 118 may be based on the difference in the latency between the lower frequency band signal path 103 and the upper frequency band signal path 113.

FIG. 4 shows an embodiment of a process 208 for the frequency domain beamforming of lower frequency band signals using the lower frequency band signal path 103 that includes the frequency domain beamformer 108. The process 208 shown in FIG. 4 may correspond to step 208 of the process 200 shown in FIG. 2. In the process 208 of FIG. 4, the audio signals received at step 204 of the process 200 may be filtered at step 402 by the low pass filter 104. The low pass filter 104 may be configured to pass the audio signals having frequencies in a lower frequency range, e.g., 0-12 kHz.

The filtered signals from the low pass filter 104 may be processed by the decimator 106 to generate the lower frequency band signals for processing by the frequency domain beamformer 108 at step 404. In particular, the decimator 106 may downsample the filtered signals by a particular factor to a lower sampling rate, as compared to the sampling rate of the audio signals received at step 204. The filtered signals may be downsampled in order to simplify the computation and complexity of processing by the frequency domain beamformer 108. In embodiments, the decimator 106 may downsample the filtered signals by a factor of 2 to a 24 kHz sampling rate from the 48 kHz sampling rate of the audio signals. In other embodiments, the decimator 106 may downsample the filtered signals by a different factor to another appropriate sampling rate.

At step 405, the decimated filtered signals may be transformed from the time domain into the frequency domain using a suitable frequency transform, such as a fast Fourier transform, a short-time Fourier transform, a discrete Fourier transform, a discrete cosine transform, or a wavelet transform. The lower frequency band signals may be processed using frequency domain beamforming techniques in order to avoid issues with excessive side lobes and the need to use a high order filter bank that may occur when using time domain beamforming techniques on lower frequency band signals.

At steps 406 and 408, the frequency domain beamformer 108 may process two groups of the lower frequency band signals using differing frequency domain beamforming techniques. While FIG. 4 shows the lower frequency band signals being processed in two groups, it is contemplated and possible for the frequency domain beamformer 108 to process more than two groups of the lower frequency band signals using two or more frequency domain beamforming techniques, in embodiments.

In embodiments, the lower frequency band signals in the frequency domain may be transformed using a weighted overlap-add (WOLA) methodology. The WOLA methodology may break up the lower frequency band signals into overlapping frames having a particular size, in order to reduce the artifacts at the boundaries between the frames. The frames may be transformed into frequency bins using a frequency transform. The frequency bins may be divided into a first group (e.g., lower frequency components of the lower frequency band signals) and into a second group (e.g., upper frequency components of the lower frequency band signals).

In embodiments, the frame size of the WOLA methodology may be configurable to allow a tradeoff between (1) latency in the lower frequency band signal path 103, and (2) computational resources and memory usage. In particular, if the frame size is smaller than or equal to a block size of the frequency transform, then the latency of the lower frequency band signal path 103 may be reduced while utilizing relatively higher computational resources and memory. The block size of the FFT transform and the frame size may be expressed in a number of samples. For example, the latency of the lower frequency band signal path 103 when the block size of the FFT transform is 256 and the frame size is 256 may be greater than the latency of the lower frequency band signal path 103 when the frame size is 128 or 192 (and when the block size of the FFT transform remains at 256), using a zero padding method to make up a whole block of data for the FFT.

At step 406, the first group of the lower frequency band signals may be processed by the frequency domain beamformer 108 using a first frequency domain beamforming technique. In embodiments, the first group may be lower frequency components of the lower frequency band signals, and the first frequency domain beamforming technique may be a superdirective beamforming technique, such as a minimum variance distortionless response (MVDR) beamforming technique. In other embodiments, the first frequency domain beamforming technique may be another appropriate superdirective beamforming technique. The frequency range of the lower frequency components of the lower frequency band signals may be dependent on the physical aperture size of the microphone array the beamformer is being used with, such as the frequencies corresponding to below the aperture size. For example, in embodiments, the lower frequency components of the lower frequency band signals may be in the range of approximately 0-1 kHz or approximately 0-2 kHz. As described previously, the weight coefficients used by the first frequency domain beamforming technique in the frequency domain beamformer 116 may be received from the weight determination unit 120 at step 202, based on the desired location and width of the beam.

At step 408, the second group of the lower frequency band signals may be processed by the frequency domain beamformer 108 using a second frequency domain beamforming technique. In embodiments, the second group may be upper frequency components of the lower frequency band signals, and the second frequency domain beamforming technique may be delay and sum beamforming technique. In other embodiments, the second frequency domain beamforming technique may be another appropriate beamforming technique. The frequency range of the upper frequency components of the lower frequency band signals may also be dependent on the physical aperture size of the microphone array the beamformer is being used with, such as the frequencies corresponding one to two octaves above the aperture size. For example, in embodiments, the lower frequency components of the lower frequency band signals may be in the range of approximately 1 kHz or 2 kHz and above. As described previously, the weight coefficients used by the second frequency domain beamforming technique in the frequency domain beamformer 116 may be received from the weight determination unit 120 at step 202, based on the desired location and width of the beam. In embodiments, steps 406 and 408 may be performed substantially at the same time or may be performed at different times.

At step 409, the signal generated by the frequency domain beamformer 108 (that is based on the first and second frequency beamforming techniques) may be transformed from the frequency domain into the time domain using a suitable inverse frequency transform, such as an inverse fast Fourier transform, an inverse short-time Fourier transform, an inverse discrete Fourier transform, an inverse discrete cosine transform, or an inverse wavelet transform. In embodiments, the transformation of the signal from the frequency domain to the time domain may use the WOLA methodology, as previously described.

At step 410, the transformed signal (based on the signal generated by the frequency domain beamformer 108) may be processed by the interpolator 110. In particular, the interpolator 110 may upsample the signal generated by the frequency domain beamformer 108 by a particular factor to a higher sampling rate. In embodiments, the interpolator 110 may upsample the signal by a factor of 2 to a 48 kHz sampling rate. In other embodiments, the interpolator 110 may upsample the signal by a different factor to another appropriate sampling rate.

The low pass filter 122 may filter the upsampled signal from the interpolator 110 at step 412, and generate the second beamformed signal that is provided to the output generation unit 122. The output generation unit 122 can combine the first and second beamformed signals at step 210 of the process 200, as described previously. The low pass filter 122 may be configured to pass components of the upsampled signal having frequencies in a lower frequency range, e.g., 0-12 kHz.

It should be noted that while FIGS. 2-4 describe that the audio signals may be divided for processing into the groups of upper frequency band signals, lower frequency components of the lower frequency band signals, and upper frequency components of the lower frequency band signals, it is contemplated and possible that the audio signal may be divided into groups for processing based on any suitable frequency ranges. Moreover, any of the groups may be processed by the superdirective beamforming technique in the frequency domain, the delay and sum beamforming technique in the frequency domain, and/or the delay and sum beamforming technique in the time domain, as appropriate.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A beamforming system, comprising:
a first beamformer configured to generate a first beamformed signal based on first frequency band signals derived from a plurality of audio signals, wherein the first beamformer is configured to process the first frequency band signals using a first beamforming technique;
a second beamformer configured to generate a second beamformed signal based on second frequency band signals derived from the plurality of audio signals, wherein the second beamformer is configured to process the second frequency band signals using a second beamforming technique; and
an output generation unit in communication with the first and second beamformers, the output generation unit configured to generate a beamformed output signal based on the first beamformed signal and the second beamformed signal.

2. The beamforming system of claim 1, wherein the first beamforming technique comprises a time domain beamforming technique and the second beamforming technique comprises a frequency domain beamforming technique.

3. The beamforming system of claim 1,
wherein the second frequency band signals comprise a first group and a second group,
wherein the second beamforming technique comprises a first frequency domain beamforming technique and a second frequency domain beamforming technique; and
wherein the second beamformer is further configured to process the first group using the first frequency domain beamforming technique and process the second group using the second frequency domain beamforming technique.

4. The beamforming system of claim 3, wherein the first and second frequency domain beamforming techniques are based on a weighted overlap-add (WOLA) methodology with a frame size that is smaller than or equal to a block size of a frequency domain transform.

5. The beamforming system of claim 4, wherein the frame size is configurable.

6. The beamforming system of claim 3, further comprising an interpolator configured to generate the second beamformed signal based on a signal generated by the first and second frequency domain beamforming techniques.

7. The beamforming system of claim 6, wherein the interpolator comprises a low pass filter configured to filter the signal generated by the first and second frequency domain beamforming techniques into a filtered signal, and the interpolator is further configured to convert the filtered signal into the second beamformed signal.

8. The beamforming system of claim 1, wherein:
the first beamforming technique comprises a delay and sum beamforming technique performed in the time domain;
the second frequency band signals comprise a first group and a second group; and
the second beamformer is further configured to process the first group using a superdirective beamforming technique performed in the frequency domain, and process the second group using a delay and sum beamforming technique in the frequency domain.

9. The beamforming system of claim 8, wherein the superdirective beamforming technique comprises a minimum variance distortionless response (MVDR) beamforming technique performed in the frequency domain.

10. The beamforming system of claim 8, wherein:
the first frequency band signals comprise upper frequency band signals;
the second frequency band signals comprise lower frequency band signals;
the first group of the lower frequency band signals comprises lower frequency components of the lower frequency band signals; and
the second group of the lower frequency band signals comprises upper frequency components of the lower frequency band signals.

11. The beamforming system of claim 1, wherein the first frequency band signals comprise upper frequency band signals and the second frequency band signals comprise lower frequency band signals.

12. The beamforming system of claim 1, further comprising a decimator configured to convert the plurality of audio signals into the second frequency band signals.

13. The beamforming system of claim 12, wherein the decimator comprises a low pass filter configured to filter the plurality of audio signals into filtered audio signals, and the decimator is further configured to convert the filtered audio signals into the second frequency band signals.

14. A method, comprising:
receiving a plurality of audio signals;
generating a first beamformed signal based on first frequency band signals derived from a plurality of audio signals, using a first beamforming technique;
generating a second beamformed signal based on second frequency band signals derived from a plurality of audio signals, using a second beamforming technique; and
generating a beamformed output signal based on the first beamformed signal and the second beamformed signal.

15. The method of claim 14, wherein the first beamforming technique comprises a time domain beamforming technique and the second beamforming technique comprises a frequency domain beamforming technique.

16. The method of claim 14,
wherein the second frequency band signals comprise a first group and a second group,
wherein the second beamforming technique comprises a first frequency domain beamforming technique and a second frequency domain beamforming technique; and
wherein generating the second beamformed signal comprises processing the first group using the first frequency domain beamforming technique and processing the second group using the second frequency domain beamforming technique.

17. The method of claim 16, wherein the first and second frequency domain beamforming techniques are based on a weighted overlap-add (WOLA) methodology with a frame size that is smaller than or equal to a block size of a frequency domain transform.

18. The method of claim 17, wherein the frame size is configurable.

19. The method of claim 16, wherein generating the second beamformed signal comprises interpolating a signal generated by the first and second frequency domain beamforming techniques to generate the second beamformed signal.

20. The method of claim 19, wherein interpolating the signal comprises:
low pass filtering the signal generated by the first and second frequency domain beamforming techniques into a filtered signal; and
converting the filtered signal into the second beamformed signal.

21. The method of claim 14, wherein:
the first beamforming technique comprises a delay and sum beamforming technique performed in the time domain;
the second frequency band signals comprise a first group and a second group; and
wherein generating the second beamformed signal comprises processing the first group using a superdirective beamforming technique performed in the frequency domain, and processing the second group using a delay and sum beamforming technique in the frequency domain.

22. The method of claim 21, wherein the superdirective beamforming technique comprises a minimum variance distortionless response (MVDR) beamforming technique performed in the frequency domain.

23. The method of claim 21, wherein:
the first frequency band signals comprise upper frequency band signals;
the second frequency band signals comprise lower frequency band signals;
the first group of the lower frequency band signals comprises lower frequency components of the lower frequency band signals; and
the second group of the lower frequency band signals comprises upper frequency components of the lower frequency band signals.

24. The method of claim 14, wherein the first frequency band signals comprise upper frequency band signals and the second frequency band signals comprise lower frequency band signals.

25. The method of claim 14, further comprising decimating the plurality of audio signals into the second frequency band signals.

26. The method of claim 25, wherein decimating the plurality of audio signals comprises:
low pass filtering the plurality of audio signals into filtered audio signals; and
converting the filtered audio signals into the second frequency band signals.

27. An array microphone, comprising:
a plurality of microphone elements each configured to generate one of a plurality of audio signals; and
a beamformer configured to generate a beamformed output signal based on the plurality of audio signals, wherein the beamformer comprises a plurality of beamformers each configured to process respective frequency band signals using a different beamforming technique, and wherein the frequency band signals are derived from a plurality of audio signals.
